(19) United States
(12) Patent Application Publication
(10) Pub. No.: US 2026/0208888 A1
(43) Pub. Date: Jul. 23, 2026

(54) SYSTEMS FOR IMAGING A TARGET OBJECT MOVING RELATIVE TO BACKGROUND FEATURES

(71) Applicant: WESTERN SYDNEY UNIVERSITY, Penrith (AU)

(72) Inventors: André van Schaik, Salford (GB); Gregory Cohen, Canberra (AU); Alexandre Marcireau, Paris (FR); Damien Joubert, Rouen (FR)

(21) Appl. No.: 19/139,082

(22) PCT Filed: Dec. 12, 2023
(86) PCT No.: PCT/AU2023/051288

§ 371 Date: Jun. 13, 2025

(30) Foreign Application Priority Data
Dec. 14, 2022 (AU) 2022903842

(51) Int. Cl. B64G 3/00; G03B 17/56; G06T 7/246; G06T 7/73; G06T 7/90; H04N 23/61; H04N 23/695

(52) U.S. Cl. CPC B64G 3/00; G03B 17/561; G06T 7/251; G06T 7/75; G06T 7/90; H04N 23/61; H04N 23/695; G06T 2207/30241; G06T 2207/30252

(57) ABSTRACT

System for imaging a target object moving relative to background features. The system includes: an event-based vision sensor operable to detect changes within a field-of-view (FOV) and, responsive to detecting changes, generate event signals; a mount carrying the event-based vision sensor and associated with a displacement mechanism operable to rotate the mount about at least one axis to direct the FOV; and a controller configured to operate the event-based vision sensor and the displacement mechanism to displace the mount at an intermediate tracking rate (r₃) to cause moving the FOV, concurrent with operating the event-based vision sensor to generate event signals, to allow imaging each of the target object and the background features moving through the FOV.

### TECHNICAL FIELD

The present disclosure relates, generally, to imaging objects moving relative to background features, and, particularly, relates to imaging resident space objects moving relative to stars.

### BACKGROUND

Space domain awareness involves monitoring resident space objects (RSO) moving near the Earth, typically being satellites orbiting the Earth. Monitoring space around the Earth may allow detecting and tracking an RSO, cataloguing the RSO, and determining the position of the RSO relative to other objects, such as another RSO. This can allow, for example, to predict, or take evasive action to avoid, collisions between RSOs, or predicting re-entry of the RSO to the Earth's atmosphere. Reliable and thorough space domain awareness has become increasingly important over recent years as the number of man-made RSOs orbiting the Earth has increased significantly.

Conventional space domain awareness is achieved by operating frame-based optical cameras, typically coupled with a telescope, to capture images of space. This approach has a number of drawbacks, including generating a substantial volume of image data, most of which showing black sky and being useless, and capturing blurred or faint images of moving objects which are difficult to process to allow obtaining any meaningful insight.

Imaging RSOs using a ground-based optical camera typically means that stars and planets are the only other features visible in the images. As RSOs move relative to the stars, it is not possible to operate an optical system such that the RSO and stars are static in the field of view, meaning that one or the other are blurred. This can mean that it is difficult to identify specific RSOs, for example, by measuring the trajectory of the RSO. One approach to attempt to resolve this is to initially operate the imaging system to track motion of the stars, so that the stars are static in the field of view. This then allows calibrating actuators which move the optical camera. The imaging system is then operated to track motion of the RSO, so that the RSO is static in the field of view. This then allows inferring the trajectory of the RSO in space. Using this approach, the precision of the trajectory measurement depends on the quality of calibration and feedback precision provided by the actuators.

Any discussion of documents, acts, materials, devices, articles or the like which has been included in the present specification is not to be taken as an admission that any or all of these matters were common general knowledge in the field relevant to the present disclosure as it existed before the priority date of each of the appended claims.

### SUMMARY

According to disclosed aspects, there is provided a system for imaging a target object moving relative to background features, the system including: an event-based vision sensor operable to detect changes within a field-of-view (FOV) and, responsive to detecting changes, generate event signals; a mount carrying the event-based vision sensor, the mount associated with a displacement mechanism operable to rotate the mount about at least one axis to cause directing the FOV; and a controller configured to operate the event-based vision sensor and the displacement mechanism. The controller is configured to: determine an imaging duration (t) starting at a specific time (t₀); determine a background tracking rate (r₁) comprising at least one first vector component defining rotation of the mount about the at least one axis to cause the background features to be stationary within the FOV; determine an object tracking rate (r₂) comprising at least one second vector component defining rotation of the mount about the at least one axis to cause the target object to be stationary within the FOV for at least a portion of the imaging duration; determine an intermediate tracking rate (r₃) comprising at least one third vector component being different to the at least one first vector component and the at least one second vector component, the at least one third vector component defining rotation of the mount about the at least one axis to cause none of the object and the background features to be stationary within the FOV; and from to, operate the displacement mechanism to displace the mount at the intermediate tracking rate (r₃) to cause moving the FOV, and operate the event-based vision sensor, for the imaging duration (t) to generate a first set of event signals to allow imaging each of the target object and the background features moving through the FOV.

The controller may be configured to determine r₃ to be balanced between r₁ and r₂ to generate the first set of event signals such that imaging the relative movement shows a velocity vector of the object moving through the FOV is substantially opposite, and of substantially equivalent magnitude, to a velocity vector of the background features moving through the FOV.

The controller may be configured to determine r₃ to be weighted towards r₂ to generate the first set of event signals such that imaging the relative movement shows that a velocity vector of the object moving through the FOV is substantially opposite to, and greater than, a velocity vector of the background features moving through the FOV.

The controller may be configured to determine r₃ to be weighted towards r₁ to generate the first set of event signals such that imaging the relative movement shows that a velocity vector of the object moving through the FOV is substantially opposite to, and less than, a velocity vector of the background features moving through the FOV.

The controller may be configured to determine r₃ as a function with respect to time, such that r₃ is variable during the imaging duration. The controller may be configured to adjust r₃ such that, for a first portion of t, the background features are moving through the FOV, and for a second portion of t, the object is moving through the FOV.

The controller may be configured to determine the target object velocity (vₒ) within the FOV and derive a tracking factor (α) as a fraction of vₒ, and the controller is further configured to determine the r₃ based on the tracking factor.

The controller may be configured to determine r₃ based on a position of the target object at a start of the imaging duration (t₀), and operate the displacement mechanism so that the target object is at the centre of the FOV halfway through the imaging duration (t₀+t/2).

The controller may be configured to estimate at least one of a velocity of the background features (v₁) within the FOV, a velocity of the target object (v₂) within the FOV, and a relative velocity of the object with respect to the background features (vᵣ) within the FOV, and responsive to estimating the at least one of v₁, v₂, and vᵣ, determine at least one of r₁ and r₂ based on v₁, v₂, or vᵣ.

The controller may be configured to periodically estimate one of the velocity of the target object (v₂), and the relative velocity of the target object with respect to the background features (vᵣ), and periodically determine r₂ based on v₂ or vᵣ, whereby responsive to determining each r₂ value, the controller is configured to determine r₃ and operate the displacement mechanism at r₃.

The system may include a processor communicatively coupled with the event-based vision sensor and configured to process the event signals to image the relative movement.

The processor may be configured to image the relative movement to show temporal changes in position of the target object and background features as trails adjacent the target object and background features.

The processor may be configured to image the trails to define one or more of a colour gradient, and a palette of different colours, defined by the temporal changes in position.

The processor may be configured to determine relative positions of the background features within the FOV, and determine the location of the target object relative to the relative positions of the background features.

The mount may be configured to be arranged at a stationary position on Earth and directed at the sky in a first direction so that the background features are defined by astronomical objects, and the controller is configured to determine r₁ as a sidereal rate based on the stationary position and the first direction.

The object may be a resident space object (RSO) orbiting the Earth, and the controller be configured to determine r₂ based on a defined orbit determination for at least a portion of the imaging duration.

The controller may be configured to determine the intermediate tracking rate based on a position of the target object defined as right ascension (RA) and declination (Dec) coordinates at a start of the imaging duration (t₀).

The mount may be configured to be arranged on a resident space object (RSO) orbiting the Earth and directed at the Earth, and the controller is configured to determine r₁ based on an orbiting rate of the RSO.

The mount may be configured to be arranged on a first resident space object (RSO) orbiting the Earth and directed at a second RSO, and the controller is configured to determine r₁ based on an orbiting rate of the first RSO.

According to other disclosed aspects, there is provided a method for imaging a target object moving relative to background features, using an event-based vision sensor operable to detect changes within a field-of-view (FOV). The method includes: determining an imaging duration (t) starting at a specific time (t₀); determining a background tracking rate (r₁) comprising at least one first vector component defining rotation of the sensor about at least one axis to cause the background features to be stationary within the FOV; determining an object tracking rate (r₂) comprising at least one second vector component defining rotation of the sensor about the at least one axis to cause the target object to be stationary within the FOV for at least a portion of the imaging duration; determining an intermediate tracking rate (r₃) comprising at least one third vector component being different to the at least one first vector component and the at least one second vector component, the at least one third vector component defining rotation about the at least one axis to cause none of the object and the background features to be stationary within the FOV; and from to, moving the sensor at the intermediate tracking rate (r₃) to cause moving the FOV, and operating the event-based vision sensor to detect changes, for the imaging duration (t) to generate a first set of event signals to allow imaging each of the target object and the background features moving through the FOV. It will be appreciated that the method may be embodied as computer instructions, which may be encoded in an application, where the instructions are configured to direct operation of a system to image the target object, such as described in the previous paragraphs.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated embodiments may comprise steps, features and/or integers disclosed herein or indicated in the specification of this application individually or collectively, and any and all combinations of two or more of said steps or features.

### BRIEF DESCRIPTION OF DRAWINGS

Embodiments will now be described by way of example only with reference to the accompany drawings in which:

FIG. 1 is a schematic view of a first embodiment of a system for tracking objects moving relative to background features;

FIG. 2 is a schematic view of a second embodiment of a system for tracking objects moving relative to background features;

FIG. 3 is a first image of a RSO moving relative to stars, the image rendered from data captured by an event-based vision sensor of the system shown in FIG. 1;

FIG. 4 is a second image of the RSO and stars shown in FIG. 3, the image rendered from data captured by an event-based vision sensor of the system shown in FIG. 1 and processed to add annotations identifying the spatial relationship between six stars and the RSO;

FIG. 5 is an image of another RSO moving relative to stars, the image rendered from data captured by the event-based vision sensor of the system shown in FIG. 1 and processed to add trails depicting temporal changes; and

FIG. 6 is an image of a further RSO moving relative to stars, and rotating about its own axis, the image rendered from data captured by the event-based vision sensor of the system shown in FIG. 1 and processed to add trails depicting temporal changes.

### DESCRIPTION OF EMBODIMENTS

In the drawings, reference numeral 10 generally designates a system 10 for imaging a target object 12 moving relative to background features 14. The system 10 includes: an event-based vision sensor 16 operable to detect changes within a field-of-view (FOV) and, responsive to detecting changes, generate event signals; a mount 18 carrying the event-based vision sensor 16, the mount 18 associated with a displacement mechanism 20 operable to rotate the mount 18 about at least one axis 22, 24 to cause directing the FOV; and a controller configured to operate the event-based vision sensor 16 and the displacement mechanism 20.

The controller is configured to: determine an imaging duration (t) starting at a specific time (t₀); determine a background tracking rate (r₁) comprising at least one first vector component defining rotation of the mount 18 about the at least one axis 22, 24 to cause the background features 14 to be stationary within the FOV; determine an object tracking rate (r₂) comprising at least one second vector component defining rotation of the mount 18 about the at least one axis 22, 24 to cause the target object 12 to be stationary within the FOV for at least a portion of the imaging duration; determine an intermediate tracking rate (r₃) comprising at least one third vector component being different to the at least one first vector component and the at least one second vector component, the at least one third vector component defining rotation of the mount 18 about the at least one axis 22, 24 to cause none of the object 12 and the background features 14 to be stationary within the FOV; and, from t₀, operate the displacement mechanism 20 to displace the mount 18 at the intermediate tracking rate (r₃) to cause moving the FOV, and operate the event-based vision sensor 16, for the imaging duration (t) to generate a first set of event signals to allow imaging each of the target object 12 and the background features 14 moving through the FOV.

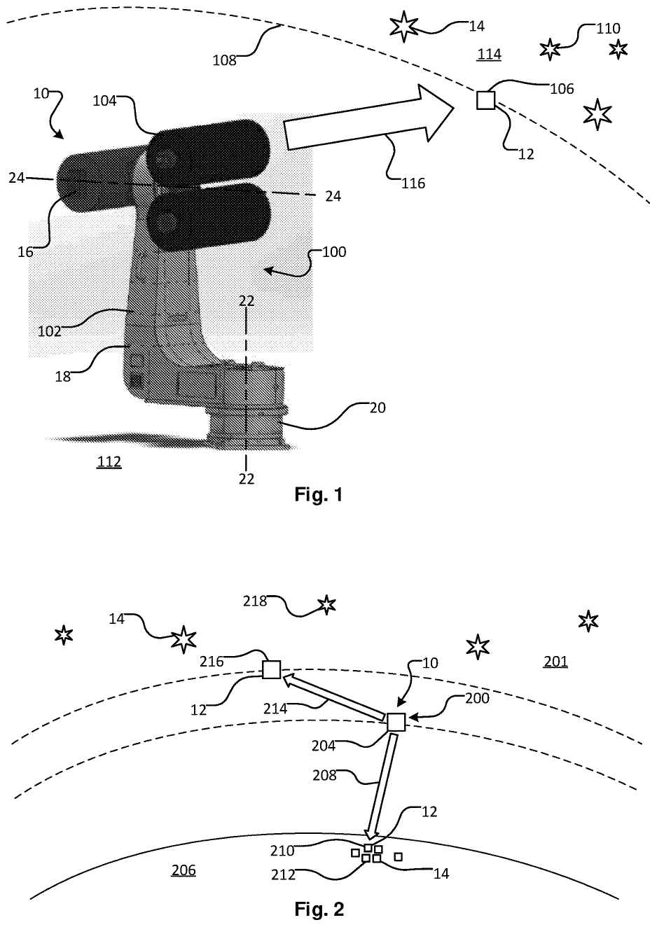

FIG. 1 shows a first embodiment 100 of the system 10 where the mount 18 is configured as a robotic altazimuth (also referred to as altitude-azimuth, or azimuth-elevation) telescope mount 102 carrying a plurality of telescopes 104. The event-based vision sensor 16 is mounted to one of the telescopes 104 such that the optics of the telescope 104 define the FOV of the sensor 16. The mount 102 defines two rotation axes about which the mount 102, or a portion of the mount 102, is rotatable. The first axis 102 is configured to be operatively vertical and the second axis 104 is orthogonal to the first axis 22 to be operatively horizontal. Rotation around the first axis 22 allows adjusting azimuth (bearing) of the pointing direction of the telescopes 104 and, as a result, adjusts the azimuth of the direction of the FOV of the sensor 16. Rotation around the second axis 24 allows adjusting altitude (angle of elevation) of the pointing direction of the telescopes 104 and, as a result, the altitude of the direction of the FOV of the sensor 16. In some embodiments (not illustrated), the mount 102 is rotatable about a single axis only, or three axes. For example, where the object 12 being tracked moves along a path having constant elevation, pivoting the FOV of the sensor 16 only about the first, vertical axis 22 may be required. In other embodiments (not illustrated), the mount 18 is configured to additionally or alternatively provide linear displacement of the FOV, such as by sliding the sensor 16 and associated telescope 104 along a track or rail.

The displacement mechanism 20 of the mount 102 includes a pair of drive motors (not shown) associated with the axes 22, 24 and operable to rotate the mount 102, or a portion of the mount 102, about each axis 22, 24. The controller of the illustrated embodiment 100 is operable to precisely control operation of each drive motor to rotate the mount 102, or a portion thereof, about each axis 22, 24 to freely direct the FOV of the sensor 16 across a wide range. The controller is typically configured to generate control signals to drive the motors responsive to receiving or determining right ascension (RA) and declination (Dec) coordinates, such as relating to a desired direction to point the FOV of the sensor 16. In this embodiment, the controller comprises, or is configured as an application executed by, a processor on-board, or proximal to, the mount 102, such as in an edge-computing device. In other embodiments, the controller is remotely hosted or executed by one or more remote processors, and controls operation of the mount 102 by communicating instructions to the mount 102, such as via the Internet. In further embodiments, the controller is hosted or executed by processors located on-board and remotely from the mount 102 in a distributed computing arrangement. For example, in this configuration of the controller, the majority of processing may be performed remotely by a powerful processor, and only some of the processing is performed locally by a basic processor.

The embodiment 100 of FIG. 1 is configured for use from a location on Earth 112 where the mount 102 is typically secured in a static position to allow directing the FOV of the sensor 16 towards the sky 114, such as illustrated by arrow 116. In some embodiments, the mount 102 is secured to, or carried by, a portable structure, such as a shipping container, or a vehicle. Use of the system 100 in this way allows imaging a target object 12 moving across the sky and within the FOV of the sensor 16. As shown in FIG. 1, the target object 12 may be a satellite 106 moving across a known, or predicted, trajectory 108 orbiting the Earth 112 and against a background of stars 110. It will be appreciated that even though the universe is expanding and therefore stars are moving relative to each other, this is happening so slowly that to a human observer the stars 110 define constant relative positions to each other to provide a static frame of reference for the motion of the satellite 106.

FIG. 2 shows an alternative embodiment 200 of the system 10 configured for use from the sky or space 201 where the mount (not shown) is carried by an airborne structure, such as a drone, or a resident space object (RSO), in this embodiment being a satellite 204 orbiting the Earth 206. In this application, the FOV of the sensor 16 is directable at the Earth 206, such as illustrated by arrow 208, to image a target object 12, for example, a vehicle 210 or an animal, which is moving relative to other objects 14 on, or near, Earth 206 and having static relative positions, such as two or more buildings 212, and/or geographic landmarks, to define a constant frame of reference. Alternatively, the FOV of the sensor 16 is directable across space 201, such as illustrated by arrow 214, to image other RSOs, such as another satellite 216 orbiting the Earth 206 against a background of stars 218.

It will be appreciated that, in other embodiments (not illustrated), the system 10 is configurable to be located on Earth 112 to image ground-based, moving target objects 12, such as vehicle or animals. For example, in some embodiments, the system 10 is configurable to monitor motion of insects, such as for agricultural purposes.

The event-based vision sensor 16 is a vision sensor operable to detect changes within its FOV. Event-based vision sensors 16 are useful for space domain awareness applications as they generally have high temporal resolution, are operable to image while being moved, generate a low data rate for sparsely populated scenes, and have a high in-frame dynamic range. It will be appreciated that event-based vision sensors 16 are distinct from conventional, frame-based vision sensors which capture a frame (image), based on detection of light, at a defined frequency. Event-based vision sensors 16 are non-linear, that is, they do not operate at a defined frequency and, instead, only generate a signal when a change is detected, as described below.

The event-based vision sensor 16 typically includes many pixels, and each pixel is operable independently of the others to act as a change detector. The sensor 16 may be configured such that each detected change causes the sensor 16 to generate an event signal if the generated photocurrent of the pixel changes by more than a defined percentage from the level at which it last emitted a change event. An “on” event signals an increase of the photocurrent, while an “off” event signals a decrease in photocurrent. These two types of event each have a separate parameter that controls the percentage change required to emit an event signal.

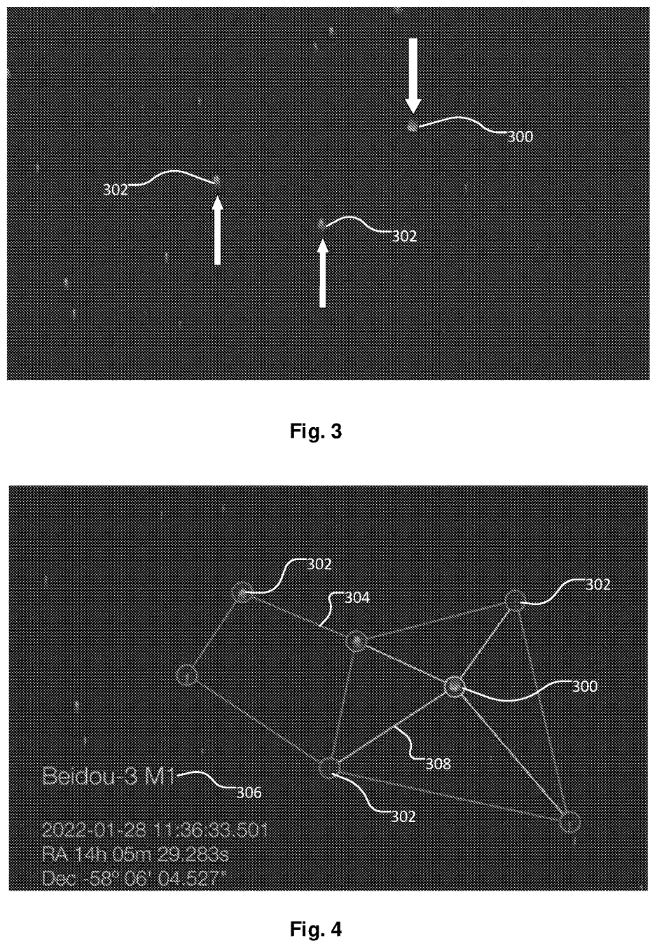

The system 10 typically includes a processor (not shown), or is communicatively coupled with a processor, configured to process the event signals received from the sensor 16 to produce images. The processor may further be configured to produce video from the images. The processor may also be configured to annotate the images to add text and/or graphics, such as to identify or categorise the object 12. Example images are shown in FIGS. 3 to 6, discussed in greater detail below.

The system 10 is configurable to move the sensor 16 to allow tracking. Tracking involves operating the displacement mechanism 20 to pivot the sensor 16 about at least one axis 22, 24 to adjust the direction of the FOV of the sensor 16. The tracking motion is performed at a tracking rate typically defined as a vector having a rotational component defining motion about the at least one axis. In the illustrated embodiment 100, the tracking rate comprises two vector components, one for each axis 22, 24, such as to define pan and tilt values for the telescopes 104 and sensor 16. The vector components are determined by an associated processor, or by the controller, and employed to control movement of the displacement mechanism 20. The tracking rate may be measured in degrees/second, or arcseconds/second.

The tracking motion effected by the displacement mechanism 20 may be configured to focus on motion of the object 12, or a portion of the object 12, such as a feature defined by the object 12, within the FOV, such as to maintain the object 12 being within the FOV. This may involve moving the FOV at a tracking rate which is matched to the motion of the object 12 such that the object 12 remains stationary in the FOV, referred to as the object tracking rate (r₁). In the embodiment 100, where the target object 12 is the satellite 106, r₁ may be derived from the orbit determination, or orbit rate, of the satellite 106. The orbit determination for known satellites is typically available from an online database, typically being defined to be valid at a certain time or for a time period. Tracking at r₁ with the event-based vision sensor 16 means that the background features 14 move within the FOV to be registered by the sensor 16 as changes, but the object 12 remains stationary within the FOV so that its motion is not registered by the sensor 16 as a change. Instead, the only detected changes relating to the object 12 are due to atmospheric light diffraction effects and/or vibrations caused by the displacement mechanism 20. As a result, visibility of the object 12 is generally intermittent and/or faint/unclear in images produced from event signals generated by the sensor 16. Such images can be of marginal usefulness for space situational awareness unless the object 12 has significant minimal brightness to allow the object 12 to be observed.

Tracking, effected by the displacement mechanism 20, may alternatively be configured to focus on tracking motion of background features 14. For example, where the system 100 is positioned on Earth 112 and directed at stars 14, the tracking motion may be configured to compensate for the Earth's rotation to maintain the stars 110 being within the FOV. This may involve moving the FOV at a tracking rate which is matched to the motion of the background features 14 such that the features 14 remain stationary in the FOV, referred to as the background tracking rate (r₂). In the embodiment 100, where the background features are the stars 110, 12 may be derived from, or equivalent to, the sidereal tracking rate. The sidereal rate may be calculated based on the static position of the mount 102 on the Earth 112 and the direction 116 the sensor 16 is pointed towards the sky 114. Tracking at 12 with the event-based vision sensor 16 means that the object 12 moves within the FOV to be registered by the sensor 16 as changes, but the background features 14 remain stationary within the FOV and only causes detected changes due to atmospheric light diffraction effects and/or vibrations of the displacement mechanism 20. As a result, visibility of the background features 14 are generally intermittent and/or faint/unclear in images produced from event signals generated by the sensor 16. Such images can be of marginal usefulness for space situational awareness unless the background features 14 have significant minimal brightness to allow the features 14 to be observed.

Tracking, effected by the displacement mechanism 20, may alternatively be configured to be at an intermediate rate (r₃) which is different to r₁ and r₂. Tracking at r₃ means that neither the background features 14 or the object 12 are stationary in the FOV, and, instead, both the background features 14 and the object 12 pass through the FOV during a time period. Tracking at r₃ with the event-based vision sensor 16 means that the background features 14 and the object 12 move within the FOV to be registered by the sensor 16 as changes. As a result, both are generally visible, even at a low brightness, in images produced from the event signals generated by the sensor 16.

The intermediate tracking rate (r₃) for a specific target object 12, and specific background features 14, may be varied within an optimal range defined by the sensor 16. Motion of the sensor 16 outside of the optimal range will mean that the object 12 and/or background features 14 move at a velocity which is greater, or less, than the response time for the sensor 16, meaning that the sensor 16 does not detect a change and does not generate an event signal.

Operation of the system 10 to allow tracking, and imaging, the target object 12 may be determined by the controller as follows: determining an imaging duration (t) starting at a specific time (t₀); determining the background tracking rate (r₁), for specific background features 14, such that r₁ comprises at least one first vector component defining rotation of the sensor 16 about at least one axis 22, 24 to cause the background features 14 to be stationary within the FOV; determining the object tracking rate (r₂) comprising at least one second vector component defining rotation of the sensor 16 about the at least one axis 22, 24 to cause the target object 12 to be stationary within the FOV for at least a portion of t; determining the intermediate tracking rate (r₃) comprising at least one third vector component being different to the at least one first vector component and the at least one second vector component, the at least one third vector component defining rotation about the at least one axis 22, 24 to cause none of the object 12 and the background features 14 to be stationary within the FOV for at least a portion of t; and from to, moving the sensor 16 at r₃ to cause moving the FOV, and operating the event-based vision sensor 16 to detect changes, throughout t to generate a first set of event signals to allow imaging each of the target object 12 and the background features 14 moving through the FOV. It will be appreciated that these steps may be embodied as computer instructions and programmed in an application executable by a processor, and therefore executed by systems other than the system 10 described above.

In some embodiments of the system 10, the controller is configured to determine r₃ to be balanced between r₁ and r₂ to generate the first set of event signals such that imaging the relative movement shows a velocity vector of the object 12 moving through the FOV to be substantially opposite, and of substantially equivalent magnitude, to a velocity vector of the background features 14 moving through the FOV. This can result in an image where the motion of the object 12 is clearly opposed to the motion of the background features. This can enhance detecting the object 12.

In some embodiments of the system 10, the controller is configured to determine r₃ to be weighted towards r₂ to generate the first set of event signals such that imaging the relative movement shows that a velocity vector of the object 12 moving through the FOV is substantially opposite to, and greater than, a velocity vector of the background features 14 moving through the FOV. Conversely, the controller may be configured to determine r₃ to be weighted towards r₁ to generate the first set of event signals such that imaging the relative movement shows that a velocity vector of the object 12 moving through the FOV is substantially opposite to, and less than, a velocity vector of the background features 14 moving through the FOV.

The intermediate tracking rate (r₃) may be determined, by the controller, for an imaging duration (t), such that r₃ is constant throughout t, or r₃ is varied during t. In some embodiments of the system 10, the controller is configured to determine r₃ as a function with respect to time to optimise duration of the target object 12 moving relative to the background features 14 within the FOV to cause generating event signals and, as a result, imaging the object 12 and background features 14. For example, where the object 12 is an RSO, such as the satellite 106 shown in FIG. 1, the satellite 106 may be moving at a velocity of sufficient magnitude that no r₃ value would cause both the stars 110 and satellite 106 to move across the FOV within the optimal range of the sensor 16, therefore requiring adjustment, or dynamic variation, of r₃ to allow imaging the stars 110 and satellite 106 by the sensor 16.

As described above, motion of the sensor 16 outside of the optimal range, for example, at a very high r₃, will mean that the object 12 and/or the background features 14 move at a velocity which is greater than the response time of the sensor 16, meaning that the sensor 16 does not detect a change defined by the object 12 and/or background features 14 and, consequently, imaging only shows the object 12, only shows the background features 14, or shows nothing at all. In this scenario, one approach to generate useful images is for the controller to be configured to recalculate and adjust the intermediate tracking rate (r₃), as a function of time, during the imaging duration (t) so that for one portion of t, such as a period at the beginning and/or the end of the duration, the sensor 16 is tracking at a first intermediate rate (r₃b) so that the background features 14 are moving across the FOV within the optimal range, and for another portion of t, such as a period during the middle of the duration, the sensor 16 is tracking at a second intermediate rate (r₃t) so that the target object 12 is moving across the FOV within the optimal range. Recalculating the r₃ values is generally based on the known r₁ and r₂ values, as described above.

To enhance signal generation and, as a result, image quality, the controller may be further configured to transition the tracking rate from r₃b to r₃t (and potentially back to r₃b). It will be appreciated that various functions of time would provide a smooth transition between the tracking rates r₃b, r₃t, such as a linear function, or a function that approximates a sigmoid function. The approach of adjusting r₃ during t allows combining imaging captured in response to event signals generated in the different portions of t to image the target object 12 moving relative to the background features 14.

In some embodiments of the system 10, the controller is configured to determine the velocity (vₒ) of the target object 12 within the FOV and derive a tracking factor (α) as a fraction of vₒ. In such embodiments, the controller is further configured to determine r₃ based on a.

Configuring operation of the system 10 may require manually defining, or automatically identifying or predicting, a position of the target object 12 at t₀. Where the object 12 is an RSO, such as the satellite 106 shown in FIG. 1, the position may be defined as RA/Dec coordinates. Determining the object's 12 position at t₀ allows operating the displacement mechanism 20 to point the FOV of the sensor 16 at, or within a defined boundary of, the position at t₀ to ensure that the object 12 and the background features 14 pass through the FOV while moving the sensor 16 at r₃ throughout period t. This may also involve the controller being configured to determine r₃ based on the position of the target object at t₀, and operating the displacement mechanism 20 so that the target object 12 is at the centre of the FOV halfway through the imaging duration (t₀+t/2).

In some applications of the system 10, the trajectory and/or velocity of target object is not able to be identified from a database or other data store, for example, where the system 10 is configured to image an unidentified ground-based target object 12, such as a vehicle, or unidentified airborne object, such as a ballistic missile. In these applications of the system 10, the controller may be configured to estimate at least one of: a velocity of the background features (v₁) within the FOV; a velocity of the target object (v₂) within the FOV; and a relative velocity of the object with respect to the background features (vᵣ) within the FOV. Responsive to estimating the at least one of v₁, v₂, and vᵣ, the controller determines at least one of r₁ and r₂ based on v₁, v₂, or vᵣ.

In these applications, the target object 12 may accelerate or decelerate, or otherwise move at non-constant velocity. In such scenarios, the controller may be configured for dynamically-adjusted tracking, where the controller periodically estimates one of the velocity of the target object (v₂), and the relative velocity of the target object 12 with respect to the background features (vᵣ), and periodically determines r₂ based on v₂ or vᵣ. Responsive to determining each r₂ value, the controller determines r₃ and operates the displacement mechanism at r₃. In such embodiments, r₃ is varied based on the periodic re-determination of r₂.

In some embodiments of the system 10, the controller executes an algorithm to effect control of the displacement mechanism 20 to direct the FOV of the sensor 16. The algorithm may be configured to predict the position of the object 12, in RA/Dec coordinates, at any point in time. The algorithm may be configured so that:
t is current time;
r is target recording duration in seconds;
α is fraction of the speed of the object 12, where α=0 is background tracking, and α=1 is object tracking; and
p(t) is position of the object 12 in RA/Dec coordinates at time t.

Executing the algorithm involves the controller effecting the following steps:
1. Control displacement of the displacement mechanism 20 to track according to

$$p ( t + \frac{r}{2} ( 1 - α ) ) ,$$

being the position where the object 12 is going to be at

$$t + \frac{r}{2} ( 1 - α ) .$$

In this scenario, the displacement mechanism 20 might initially be pointing the FOV of the sensor 16 in a different direction but it will eventually reach this moving direction at t₀.
2. Operate the sensor 16 to start recording (detecting changes) at (t=t₀), and control the displacement mechanism 20 to track

$$p ( t + \frac{r}{2} ( 1 - α ) ( 1 - \frac{2 ( t - {t}_{0} )}{r} ) )$$

3. At t₀+r, cease operation of the sensor 16. The displacement mechanism 20 should be pointing at

$$\frac{r}{2} ( 1 - α )$$

behind the object 12.

In this configuration, an a value between 0 and 1 results in both the object 12 and the background features 14 moving within the FOV. For some applications it is preferable that α=0.5 so that the background features 14 and object 12 move with equivalent speed through the FOV.

During the recording period, the apparent visual velocity of the object 12 in the FOV is (1−α) times its visual velocity relative to the background features 14. The apparent visual velocity of the background features 14 in the FOV is a times the visual velocity of the object 12 relative to the background features 14. The displacement mechanism 20 will point exactly at the object 12 at

$${t}_{0} + \frac{r}{2} .$$

Combining a small α value with a large r period may cause the object 12 to be outside the FOV of the sensor 12 at a beginning and/or end period of the recording, especially if the FOV is small or the object 12 is fast. However, the object 12 will always cross the FOV in the middle of the recording period.

For some applications, the a value may be adjusted during the recording period to effectively decrease the velocity of the object 12, or the background features 14, within the FOV.

FIGS. 3 to 6 show images of the target object 12, in these figures being an RSO 300, moving relative to background features 14, in these figures being stars 302. The images have been produced from the event signals generated by the sensor 16 of the system 100 being operated throughout time period t, and moved by the displacement mechanism 20 at the intermediate tracking rate r₃, according to the above described approach. It will be appreciated that the same images may be produced by the system 200 being directed across space 201 such as at the orbiting satellite 216.

In FIG. 3, the changes of position of the RSO 300 detected by the sensor 16 cause the RSO 300 to be shown with a blur extending behind the object, in this image, extending vertically upwards. The changes of position of the stars 302 detected by the sensor 16 cause the stars 302 to be shown with a blur extending behind each star 302, in this image, extending vertically downwards. When multiple images generated in this way are shown in sequence, as video footage, it is clear to an observer, or software configured for analysis of the images, that the RSO 300 is moving downwards, while the stars 302 are moving upwards. Furthermore, as the RSO 300 is the only feature in the image moving in a different direction to the stars 302, it is readily apparent to the observer, or relevant analytical software, that the RSO 300 is not a star 302 and therefore requires further investigation to allow identifying the RSO 300.

FIG. 4 shows the same RSO 300 shown in FIG. 3 at a later point during the imaging period t. The processor associated with the system 10 is configured to identify known positional relationships between stars 302 shown in the images based on the event signals generated by the sensor 16, such as by the processor referring to one or more databases. In this example, the processor has determined that some of the stars 302 in the image belong to a known star constellation and added annotations, being a network of lines 304, to the image to illustrate the constellation. In this example, the system 100 is configured to track a specific RSO 300 based on catalogued orbital data, typically obtained from a database, and therefore identifies the RSO 300 as satellite “Beidou-3 M1” of the BeiDou Navigation Satellite System (BDS). Based on this data, the processor adds further annotations, including text 306 and additional lines 308, to the image to identify the RSO 300.

In some embodiments, the system 100 may not be provided with information about the RSO 300, or may have received this information but be configured to verify the information before adding the further annotations 306, 308 to the image. In such embodiments, the processor associated with the system 100 may be configured such that, using the constellation indicated by the network of lines 304 as a frame of reference, the processor refers to one or more databases of orbit determinations for known satellites to determine if any satellite could be observed from the location of the mount 102 to be orbiting past the constellation during the imaging period. In the example illustrated by FIG. 4, the processor determines that a satellite of the BeiDou Navigation Satellite System (BDS) belonging to the third generation (BDS-3) of satellites, specifically “Beidou-3 M1”, is the most likely known satellite to be present in the imaged region, and, as a result, identifies the RSO 300 as this satellite. This causes the processor to add the further annotations 306, 308 to the image to identify the RSO 300.

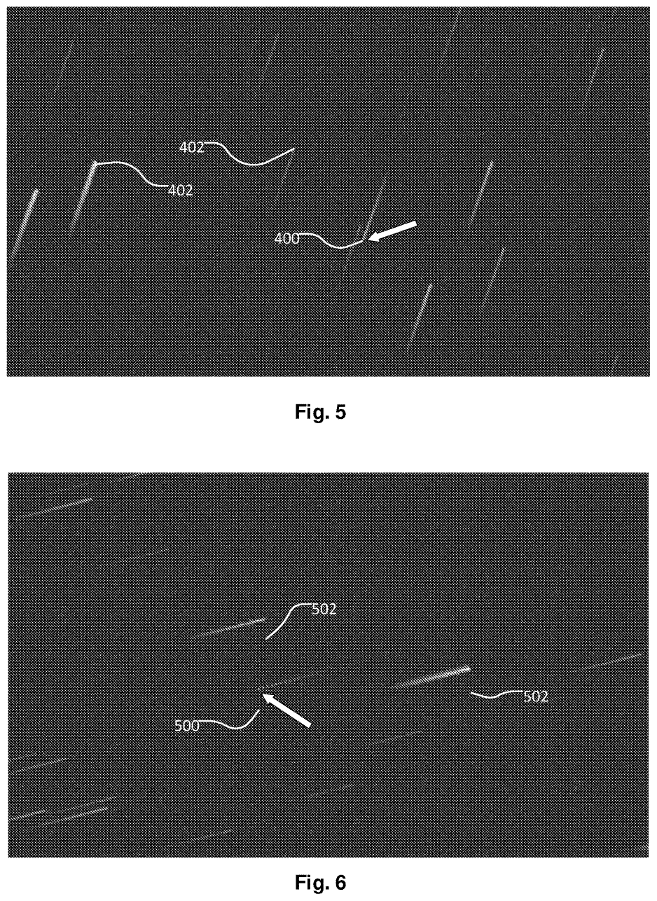

FIG. 5 is an image of another RSO 400 moving relative to other stars 402. In this image, the processor has enhanced the blur extending behind each moving feature to show these as trails to better show temporal changes. In some applications, the trails are shown as a gradient of a colour, or a gradient of a palette of colours, which may include the full spectrum of visible light colours, to enhance conveying the changes to the observer or relevant analytical software. This may involve assigning different colours to different timestamps, for example, red=t−0.2 seconds, and violet=t−1 second.

FIG. 6 is an image of yet another RSO 500 moving relative to other stars 502. In this image, the processor has again enhanced the motion blur to show trails behind each moving feature. The trail associated with the RSO 500 is depicted as a dashed line. This indicates that changes defined by this RSO 500 have intermittently been detected. This is likely because the RSO 500 is spinning about its own axis, meaning that light is intermittently reflecting (glinting) from the RSO 500 to only allow intermittent detection.

The system 10 involves moving the sensor 16, to adjust direction of the FOV, while detecting changes within the FOV. The sensor 16 is moved at a defined tracking rate (r₃) based on, and different to, the background tracking rate (r₁) and the object tracking rate (r₂). Tracking at (r₃) means that the object 12 and the background features 14 move across the FOV to cause changes to be detected and event signals generated. As a result, both the object 12 and the background features 14 are shown in an image derived from the event signals. The system 10 can therefore allow rapid detection, and potential identification, of the object 12. Moving the sensor 16 while imaging can also allow scanning a large area, such as to search for moving RSOs, in little time. Furthermore, as the sensor 16 only generates event signals responsive to a change detected by a pixel, the data generated by the system 10 is typically low, which can reduce latency, or otherwise enhance efficiency of post-processing the event signals.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A system for imaging a target object moving relative to background features, the system including:
an event-based vision sensor operable to detect changes within a field-of-view (FOV) and, responsive to detecting changes, generate event signals;
a mount carrying the event-based vision sensor, the mount associated with a displacement mechanism operable to rotate the mount about at least one axis to cause directing the FOV; and
a controller configured to operate the event-based vision sensor and the displacement mechanism, the controller configured to:
determine an imaging duration (t) starting at a specific time (t₀);
determine a background tracking rate (r₁) comprising at least one first vector component defining rotation of the mount about the at least one axis to cause the background features to be stationary within the FOV;
determine an object tracking rate (r₂) comprising at least one second vector component defining rotation of the mount about the at least one axis to cause the target object to be stationary within the FOV for at least a portion of the imaging duration;
determine an intermediate tracking rate (r₃) comprising at least one third vector component being different to the at least one first vector component and the at least one second vector component, the at least one third vector component defining rotation of the mount about the at least one axis to cause none of the object and the background features to be stationary within the FOV; and
from t₀, operate the displacement mechanism to displace the mount at the intermediate tracking rate (r₃) to cause moving the FOV, and operate the event-based vision sensor, for the imaging duration (t) to generate a first set of event signals to allow imaging each of the target object and the background features moving through the FOV.

2. The system of claim 1, wherein the controller is configured to determine r₃ to be balanced between r₁ and r₂ to generate the first set of event signals such that imaging the relative movement shows a velocity vector of the object moving through the FOV is substantially opposite, and of substantially equivalent magnitude, to a velocity vector of the background features moving through the FOV.

3. The system of claim 1, wherein the controller is configured to determine r₃ to be weighted towards r₂ to generate the first set of event signals such that imaging the relative movement shows that a velocity vector of the object moving through the FOV is substantially opposite to, and greater than, a velocity vector of the background features moving through the FOV.

4. The system of claim 1, wherein the controller is configured to determine r₃ to be weighted towards r₁ to generate the first set of event signals such that imaging the relative movement shows that a velocity vector of the object moving through the FOV is substantially opposite to, and less than, a velocity vector of the background features moving through the FOV.

5. The system of claim 1, wherein the controller is configured to determine r₃ as a function with respect to time, such that r₃ is variable during the imaging duration.

6. The system of claim 1, wherein the controller is configured to determine the target object velocity (vₒ) within the FOV and derive a tracking factor (α) as a fraction of vₒ, and the controller is further configured to determine the r₃ based on the tracking factor.

7. The system of claim 1, wherein the controller is configured to determine r₃ based on a position of the target object at a start of the imaging duration (t₀), and operate the displacement mechanism so that the target object is at the centre of the FOV halfway through the imaging duration (t₀+t/2).

8. The system of claim 1, wherein the controller is configured to estimate at least one of a velocity of the background features (v₁) within the FOV, a velocity of the target object (v₂) within the FOV, and a relative velocity of the object with respect to the background features (vᵣ) within the FOV, and responsive to estimating the at least one of v₁, v₂, and vᵣ, determine at least one of r₁ and r₂ based on v₁, v₂, or vᵣ.

9. The system of claim 8, wherein the controller is configured to periodically estimate one of the velocity of the target object (v₂), and the relative velocity of the target object with respect to the background features (vᵣ), and periodically determine r₂ based on v₂ or vᵣ, whereby responsive to determining each r₂ value, the controller is configured to determine r₃ and operate the displacement mechanism at r₃.

10. The system of claim 1, further including a processor communicatively coupled with the event-based vision sensor and configured to process the event signals to image the relative movement.

11. The system of claim 10, wherein the processor is configured to image the relative movement to show temporal changes in position of the target object and background features as trails adjacent the target object and background features.

12. The system of claim 11, wherein the processor is configured to image the trails to define one or more of a colour gradient, and a palette of different colours, defined by the temporal changes in position.

13. The system of claim 10, wherein the processor is configured to determine relative positions of the background features within the FOV, and determine the location of the target object relative to the relative positions of the background features.

14. The system of claim 1, wherein the mount is configured to be arranged at a stationary position on Earth and directed at the sky in a first direction so that the background features are defined by astronomical objects, and the controller is configured to determine r₁ as a sidereal rate based on the stationary position and the first direction.

15. The system of claim 14, wherein the object is a resident space object (RSO) orbiting the Earth, and the controller is configured to determine 12 based on a defined orbit determination for at least a portion of the imaging duration.

16. The system of claim 15, wherein the controller is configured to determine the intermediate tracking rate based on a position of the target object defined as right ascension (RA) and declination (Dec) coordinates at a start of the imaging duration (t₀).

17. The system of claim 1, wherein the mount is configured to be arranged on a resident space object (RSO) orbiting the Earth and directed at the Earth, and the controller is configured to determine r₁ based on an orbiting rate of the RSO.

18. The system of claim 1, wherein the mount is configured to be arranged on a first resident space object (RSO) orbiting the Earth and directed at a second RSO, and the controller is configured to determine r₁ based on an orbiting rate of the first RSO.

19. A method for imaging a target object moving relative to background features, using an event-based vision sensor operable to detect changes within a field-of-view (FOV), the method including:
determining an imaging duration (t) starting at a specific time (t₀);
determining a background tracking rate (r₁) comprising at least one first vector component defining rotation of the sensor about at least one axis to cause the background features to be stationary within the FOV;
determining an object tracking rate (r₂) comprising at least one second vector component defining rotation of the sensor about the at least one axis to cause the target object to be stationary within the FOV for at least a portion of the imaging duration;
determining an intermediate tracking rate (r₃) comprising at least one third vector component being different to the at least one first vector component and the at least one second vector component, the at least one third vector component defining rotation about the at least one axis to cause none of the object and the background features to be stationary within the FOV; and
from t₀, moving the sensor at the intermediate tracking rate (r₃) to cause moving the FOV, and operating the event-based vision sensor to detect changes, for the imaging duration (t) to generate a first set of event signals to allow imaging each of the target object and the background features moving through the FOV.
